(19) United States
(12) Patent Application Publication
(10) Pub. No.: US 2012/0112725 A1
(43) Pub. Date: May 10, 2012

(54) Circuit and Method for Voltage Regulator Output Voltage Trimming

(76) Inventors: Yike Li, Chengdu (CN); Jiangyun Zhou, Chengdu (CN)

(21) Appl. No.: 13/282,744

(22) Filed: Oct. 27, 2011

(30) Foreign Application Priority Data
Nov. 5, 2010 (CN) 201010533723.X

(51) Int. Cl. G05F 1/648

(52) U.S. Cl. 323/297

(57) ABSTRACT

The present disclosure discloses a voltage regulator comprising a trimming circuit. The present disclosure also discloses a method for trimming an output voltage of a voltage regulator. In one embodiment the voltage regulator may comprise a power conversion module, a feedback and trimming module and a control module. The voltage regulator may be able to provide an output voltage that could be regulated to a plurality of output values, the feedback and trimming module may be able to trim the plurality of output values to their desired values successively and independently.

### CROSS-REFERENCE TO RELATED APPLICATION(S)

This application claims priority to and the benefit of Chinese Patent Application No. 201010533723.X, filed Nov. 5, 2010, which is incorporated herein by reference in its entirety.

### TECHNICAL FIELD

This disclosure relates generally to voltage regulators, and particularly relates to apparatus and method for trimming an output voltage of a voltage regulator.

### BACKGROUND

The statements in this section merely provide background information related to the present invention and may not constitute prior art.

Voltage regulators are widely used as power supplies for various electrical/electronic devices. Generally, a voltage regulator employs negative feedback regulation for regulating its output voltage at a desired value. In some applications, it is desired that the voltage regulator provides an output voltage having a plurality of different regulated values, for example, when the voltage regulator is used for linearly charging a plurality of batteries.

FIG. 1 illustrates schematically a voltage regulator 100 comprising: a power conversion module 101, a control module 103, and a feedback module 105, wherein the power conversion module 101 is configured to receive an input voltage Vᵢₙ and to provide an output voltage Vₒᵤₜ; and wherein the feedback module 105 is configured to receive the output voltage Vₒᵤₜ and to provide a feedback signal V_{fb} that is related to the output voltage Vₒᵤₜ to the control module 103; and wherein the control module 103 is configured to receive on the one hand the feedback signal V_{fb}, and on the other hand a reference signal V_{ref}, and to provide a control signal V_{C} based on an error between the feedback signal V_{fb} and the reference signal V_{ref} to the power conversion module 101 to regulate the power conversion module 101 to convert the input voltage Vᵢₙ into the output voltage Vₒᵤₜ.

Theoretically, the output voltage Vₒᵤₜ of the voltage regulator 100 may be configured to have a plurality of different regulated output values either by setting the reference signal V_{ref} to have a plurality of different reference values corresponding to the plurality of different regulated output values, or by setting the feedback module 105 to monitor the output voltage Vₒᵤₜ at a plurality of different feedback points so that the feedback signal V_{fb} has a plurality of different feedback values corresponding to the plurality of different regulated output values. However, if one or more of the plurality of regulated output values are relatively small, the corresponding reference value/values may be too small to accurately generate. Thus, in practical, the output voltage Vₒᵤₜ is configured to have a plurality of different regulated output values generally by setting the feedback module 105 to monitor the output voltage Vₒᵤₜ at a plurality of different feedback points.

FIG. 2 illustrates schematically a voltage regulator 200 capable of providing an output voltage Vₒᵤₜ having two different regulated output values Vₒᵤₜ₁ and Vₒᵤₜ₂. Components or structures in the voltage regulator 200 with substantially the same functions as those of the voltage regulator 100 are identified by the same reference labels as used in the voltage regulator 100 for the sake of simplicity. The feedback module 105 exemplarily comprises a first feedback resistor R₁, a second feedback resistor R₂, and a third feedback resistor R₃ coupled in order and in series between the output voltage Vₒᵤₜ and ground, wherein the connection between the first feedback resistor R₁ and the second feedback resistor R₂ forms a first feedback point FB₁, and wherein the connection between the second resistor R₂ and the third feedback resistor R₃ forms a second feedback point FB₂. When the feedback module 105 provides the feedback signal V_{fb} from the first feedback point FB₁, the feedback signal V_{fb} has a first feedback value V_{fb1}. In this case, the output voltage Vₒᵤₜ is regulated at a first output value Vₒᵤₜ₁ based on a difference between the first feedback value V_{fb1} and the reference signal V_{ref}. When the feedback module 105 provides the feedback signal V_{fb} from the second feedback point FB₂, the feedback signal V_{fb} has a second feedback value V_{fb2}. In this case, the output voltage Vₒᵤₜ is regulated at a second output value Vₒᵤₜ₂ based on a difference between the second feedback value V_{fb2} and the reference signal V_{ref}. The first regulated output value Vₒᵤₜ₁ and the second regulated output value Vₒᵤₜ₂ may respectively be expressed as follows:

$$\begin{matrix}{Vout}_{1} = \frac{( {R}_{1} + {R}_{2} + {R}_{3} ) Vref}{{R}_{1}} & ( 1 ) \\ {Vout}_{2} = \frac{( {R}_{1} + {R}_{2} + {R}_{3} ) Vref}{{R}_{1} + {R}_{2}} & ( 2 )\end{matrix}$$

Usually, due to the influences from process, temperature and parasitic parameters etc., the output values of the output voltage Vₒᵤₜ may deviate from their desired values. For the voltage regulator illustrated in FIG. 2, supposing that both the first output value Vₒᵤₜ₁ and the second output value Vₒᵤₜ₂ are deviated from their desired values, for example, lower than their desired values, generally trimming may be applied to the first feedback resistor R₁ to correct the first output value Vₒᵤₜ₁, the second feedback resistor R₂ and the third feedback resistor R₃ to correct the second output value Vₒᵤₜ₂. On one hand, according to the expression (2), we may firstly trim the third feedback resistor R₃ to have its resistance increased while keep the first feedback resistor R₁ and the second feedback resistor R₂ unchanged such that the second output value Vₒᵤₜ₂ is increased to its desired value; on the other hand, according to the expression (1), increasing the resistance of R₂+R₃ while keeping R₁ unchanged may help to increase the first output value Vₒᵤₜ₁ to its desired value, however, since R₃ has already been appropriately trimmed to have the second output value Vₒᵤₜ₂ reach its desired value, we may just trim R₂ to increase the resistance of R₂+R₃ to have the first output value Vₒᵤₜ₁ reach its desired value. But referring to the expression (2) again, when the second feedback resistor R₂ is trimmed, the second output value Vₒᵤₜ₂ may deviate from its desired value again, needing to trim R₃ again. Nevertheless, through such repeat trimming to the second feedback resistor R₂ and the third feedback resistor R₃, it is still hard to obtain satisfied trimming results for the first output value Vₒᵤₜ₁ and the second output value Vₒᵤₜ₂.

To resolve the above mentioned problem, an alternative voltage regulator 300 as illustrated in FIG. 3 may be provided, wherein the feedback module 105 may comprise a first resistor divider comprising a first feedback resistor R₁ and a second feedback resistor R₂ coupled in series between the output voltage Vₒᵤₜ and ground, and a second resistor divider comprising a third feedback resistor R₃ and a fourth feedback resistor R₄ coupled in series between the output voltage Vₒᵤₜ and ground. In this configuration, the connection between the first feedback resistor R₁ and R₂ forms the first feedback point FB₁, and the connection between the third feedback resistor R₃ and the fourth feedback resistor R₄ forms the second feedback point FB₂. The first output value Vₒᵤₜ₁ and the second output value Vₒᵤₜ₂ may be expressed as follows:

$$\begin{matrix}{Vout}_{1} = \frac{( {R}_{1} + {R}_{2} ) Vref}{{R}_{1}} & ( 3 ) \\ {Vout}_{2} = \frac{( {R}_{3} + {R}_{4} ) Vref}{{R}_{3}} & ( 4 )\end{matrix}$$

In this case, still supposing that both the first output value Vₒᵤₜ₁ and the second output value Vₒᵤₜ₂ are deviated from their desired values, we may respectively trim the second feedback resistor R₂ and the fourth feedback resistor R₄ for respectively trimming the first output value Vₒᵤₜ₁ and the second output value Vₒᵤₜ₂ to their desired values. However, the using of two separate resistor dividers to provide the first feedback value V_{fb1} and the second feedback value V_{fb2} respectively corresponding to the first output value Vₒᵤₜ₁ and the second output value Vₒᵤₜ₂ simplifies the trimming for the output values Vₒᵤₜ₁ and Vₒᵤₜ₂ at the expense of increasing the power loss and chip size of the voltage regulator. This disadvantage becomes more obvious when more than two different output values are desired.

### SUMMARY

In accordance with one embodiment, a voltage regulator comprises: a power conversion module configured to receive an input voltage, and to convert the input voltage into an output voltage configurable to be regulated to a plurality of output values indexed from 1 to N, wherein N is a positive integer; a feedback and trimming module comprising a plurality of voltage dividing devices coupled in series between the output voltage and ground, wherein the feedback and trimming module is configured to provide a plurality of feedback terminals indexed from 1 to N leading out from N different positions on the plurality of voltage dividing devices, and wherein the plurality of feedback terminals indexed from 1 to N are configured to provide a plurality of feedback voltages indexed from 1 to N respectively corresponding to the plurality of output values indexed from 1 to N; and a control module configured to selectively receive one of the plurality of feedback voltages indexed by X a time, and to compare the received feedback voltage indexed by X with a reference signal to provide a control signal to the power conversion module, wherein the control signal represents an error between the received feedback voltage indexed by X and the reference signal, and wherein the power conversion module regulates the output voltage to the output value indexed by X corresponding to the received feedback voltage indexed by X in response to the control signal, and wherein X changes from 1 to N; and wherein the feedback and trimming module is further configured to successively trim the leading out positions of the plurality of feedback terminals indexed from 1 to N on the plurality of voltage dividing devices so as to successively trim the plurality of output values indexed from 1 to N to their desired values independently.

In accordance with one embodiment, a trimming circuit comprises: an input terminal configured to receive an output voltage of a voltage regulator configurable to be regulated to a plurality of output values indexed from 1 to N, wherein N is a positive integer; a plurality of feedback terminals indexed from 1 to N configured to provide a plurality of feedback voltages indexed from 1 to N corresponding to the plurality of output values indexed from 1 to N; and a plurality of voltage dividing devices coupled in series between the input terminal and ground, wherein the plurality of feedback terminals indexed from 1 to N are provided from N different leading out positions on the plurality of voltage dividing devices, and wherein the plurality of output values indexed from 1 to N corresponding to the plurality of feedback voltages indexed from 1 to N are successively and independently trimmed to their desired values via successively trimming the leading out positions of the plurality of feedback terminals indexed from 1 to N on the plurality of voltage dividing devices.

In accordance with one embodiment, a method for trimming an output voltage of a voltage regulator, comprises: coupling a plurality of voltage dividing devices in series between the output voltage and ground; providing a plurality of feedback terminals indexed from 1 to N leading out from N different positions on the plurality of voltage dividing devices, wherein N is a positive integer, and wherein the plurality of feedback terminals having a plurality of feedback voltages indexed from 1 to N respectively corresponding to a plurality of output values indexed from 1 to N of the output voltage; and trimming the leading out positions of the plurality of feedback terminals indexed from 1 to N on the plurality of voltage dividing devices successively so as to trim the plurality of output values indexed from 1 to N successively and independently.

### BRIEF DESCRIPTION OF THE DRAWINGS

The following detailed description of the embodiments of the present invention can best be understood when read in conjunction with the following drawings, in which the features are not necessarily drawn to scale but rather are drawn as to best illustrate the pertinent features.

FIG. 1 illustrates schematically a voltage regulator 100.

FIG. 2 illustrates schematically a voltage regulator 200 capable of providing an output voltage having two different regulated output values.

FIG. 3 illustrates schematically another voltage regulator 300 capable of providing an output voltage Vₒᵤₜ having two different regulated output values.

FIG. 4 illustrates schematically a voltage regulator 400 in accordance with one embodiment of the present invention.

FIG. 5 illustrates schematically a trimming unit of the voltage regulator 400 in accordance with one embodiment of the present invention.

FIG. 6 illustrates schematically a voltage regulator 600 capable of providing an output voltage having two different regulated output values in accordance with one embodiment of the present invention.

FIG. 7 illustrates a flow chart of a method for trimming an output voltage of a voltage regulator in accordance with one embodiment of the present invention.

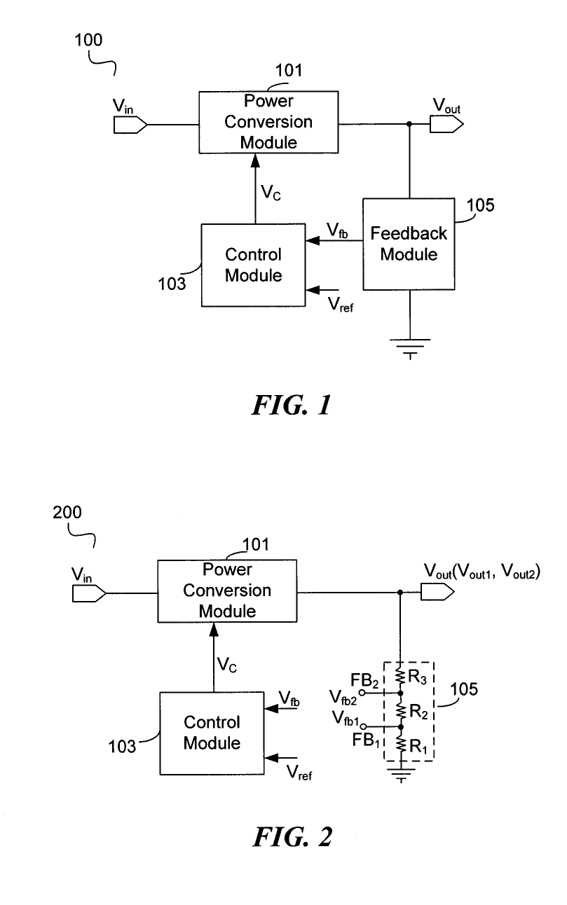

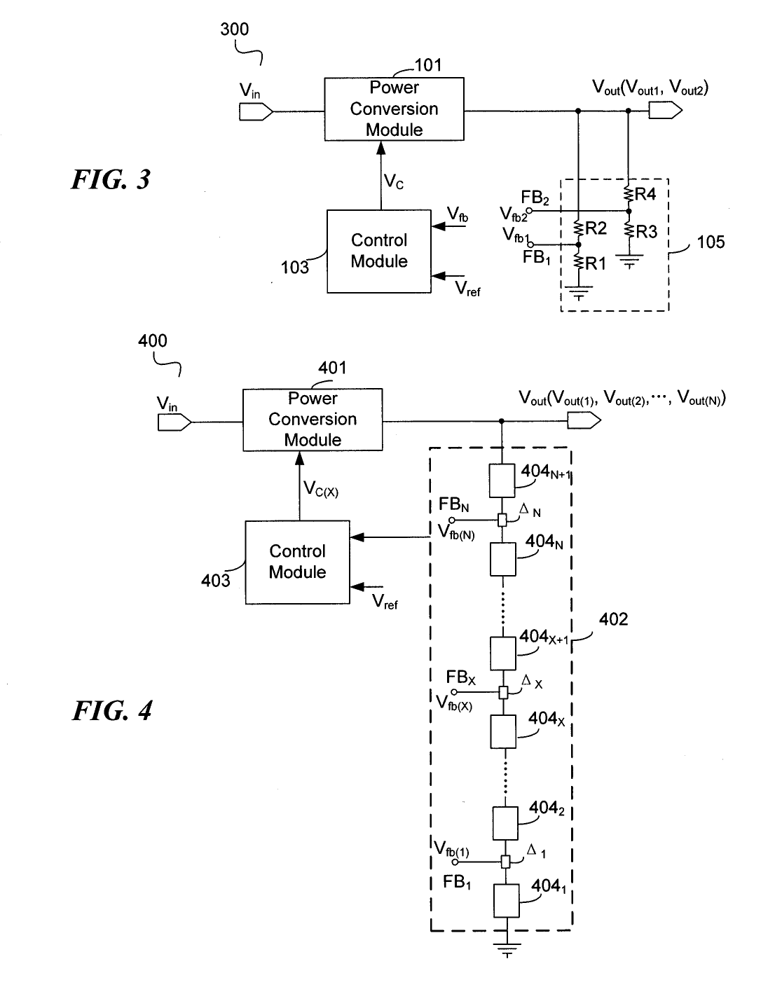

### DETAILED DESCRIPTION

Various embodiments of the present invention will now be described. In the following description, some specific details, such as example circuits and example values for these circuit components, are included to provide a thorough understanding of the embodiments. One skilled in the relevant art will recognize, however, that the present invention can be practiced without one or more specific details, or with other methods, components, materials, etc. In other instances, well-known structures, materials, processes or operations are not shown or described in detail to avoid obscuring aspects of the present invention.

FIG. 4 illustrates schematically a voltage regulator 400 in accordance with an embodiment of the present invention. The voltage regulator 400 comprises a power conversion module 401 configured to receive an input voltage Vᵢₙ, and to convert the input voltage Vᵢₙ into an output voltage Vₒᵤₜ configurable to be regulated to a plurality of output values Vₒᵤₜ₍₁₎˜V_{out(N)}, wherein N is a positive integer; a feedback and trimming module 402 comprising a plurality of voltage dividing devices coupled in series between the output voltage Vₒᵤₜ and ground, wherein the feedback and trimming module 402 is configured to provide a plurality of feedback terminals FB₁˜FB_{N} leading out from a plurality of different positions on the plurality of voltage dividing devices, and wherein the plurality of feedback terminals FB₁˜FB_{N} are respectively configured to provide a plurality of feedback voltages V_{fb(1)}˜V_{fb(N)} respectively corresponding to the plurality of output values Vₒᵤₜ₍₁₎˜V_{out(N)}; and a control module 403 configured to selectively receive one of the plurality of feedback voltages V_{fb(1)}˜V_{fb(N)} identified by V_{fb(X)}, and to compare the received feedback voltage V_{fb(X)} with a reference signal V_{ref} to provide a control signal V_{C(X)} to the power conversion module 401, wherein the control signal V_{C(X)} represents an error between the feedback voltage V_{fb(X)} and the reference signal V_{ref}, and wherein the power conversion module 401 regulates the output voltage Vₒᵤₜ to the output value V_{out(X)} in response to the control signal V_{C(X)}, and wherein X may change from 1 to N. In this way, the voltage regulator 400 may be able to convert the input voltage Vᵢₙ into the output voltage Vₒᵤₜ configurable to have a plurality of output values Vₒᵤₜ₍₁₎˜V_{out(N)} via negative feedback regulation. The output voltage Vₒᵤₜ is regulated to which one of the plurality of output values Vₒᵤₜ₍₁₎˜V_{out(N)} depends on which one of the plurality of feedback signals V_{fb(1)}˜_{fb(N)} is provided to the control module 403 to compare with the reference signal V_{ref}.

In accordance with the exemplary embodiment shown in FIG. 4, when the plurality of output values Vₒᵤₜ₍₁₎˜V_{out(N)} are deviated from their desired values, the feedback and trimming module 402 may be configured to successively trim the leading out positions of the plurality of feedback terminals FB₁˜FB_{N} on the plurality of voltage dividing devices so as to successively trim the plurality of feedback voltages V_{fb(1)}˜V_{fb(N)} such that the plurality of output values Vₒᵤₜ₍₁)•V_{out(N)} are correspondingly successively trimmed to their desired values. In this way, the trimming for two successive feedback voltages V_{fb(X)} and V_{fb(X+1)} is independent, and thus the trimming for two successive output values V_{out(X)} and V_{out(X+1)} is independent, wherein X may change from 1 to (N−1). That is to say, the plurality of output values Vₒᵤₜ₍₁₎˜V_{out(N)} corresponding to the plurality of feedback voltages V_{fb(1)}˜V_{fb(N)} are successively trimmed to their desired values via successively trimming the leading out positions of the plurality of feedback terminals FB₁˜FB_{N} on the plurality of voltage dividing devices; and the trimming for the plurality of output values Vₒᵤₜ₍₁₎˜V_{out(N)} is independent.

In one embodiment, the feedback and trimming module 402 may comprise a group of resistive voltage dividing devices 404₁-404_{N+1} coupled in series between the output voltage Vₒᵤₜ and ground with a terminal of the resistive voltage dividing device 404₁ connected to ground and a terminal of the resistive voltage dividing device 404_{N+1} connected to the output voltage Vₒᵤₜ; and a group of trimming units Δ₁˜Δ_{N} configured to provide the plurality of feedback terminals FB₁˜FB_{N}, wherein the trimming unit Δ_{X} is coupled between the resistive voltage dividing devices 404_{X} and 404_{X+1}, and wherein the trimming unit Δ_{X} is configured to provide the feedback terminal FB_{X} at a predetermined leading out position on the trimming unit Δ_{X} before trimming; and wherein the trimming unit Δ_{X} is further configured to trim the leading out position of the feedback terminal FB_{X} on the trimming unit Δ_{X} so as to trim the feedback voltage V_{fb(X)} such that the corresponding output value V_{out(X)} could be trimmed to its desired value; and wherein X changes from 1 to N successively. In this case, the output values V_{out(1)˜V}_{out(N)} may be successively trimmed to their desired values by successively trimming the leading out positions of the feedback terminals FB₁˜FB_{N} on the trimming units Δ₁˜Δ_{N}.

In one embodiment, the resistive voltage dividing device 404_{X} has an equivalent resistance identified by R_{X}; and the trimming unit Δ_{X} has an equivalent resistance identified by ΔR_{X}. For the simplicity of explanation, in an exemplary embodiment, the predetermined leading out position of the feedback terminal FB_{X} before trimming is at the middle of the trimming unit Δ_{X}. Thus, the output values Vₒᵤₜ₍₁₎˜V_{out(N)} may be expressed by the following equations:

$$\begin{matrix}{V}_{out ( X )} = \frac{{R}_{total} \times Vref}{{R}_{X}^{′} + {R}_{X - 1}^{′} + … + {R}_{1}^{′}} ( X = 1 , … , N ) \\ wherein \text{:} & ( 5 ) \\ {R}_{total} = {\sum }_{X = 1}^{X = N} ( {R}_{X} + Δ {R}_{X} ) + {R}_{N + 1} & ( 6 ) \\ {R}_{X}^{′} = {R}_{X} + \frac{1}{2} Δ {R}_{X - 1} + \frac{1}{2} Δ {R}_{X} ( X = 2 , … , N ) \\ and & ( 7 ) \\ {R}_{1}^{′} = {R}_{1} + \frac{1}{2} Δ {R}_{1} & ( 8 )\end{matrix}$$

From the expressions (5)˜(8), it can be seen that the output values Vₒᵤₜ₍₁₎˜V_{out(N)} may be successively trimmed by successively trimming the resistances R′₁˜R′_{N}. In this way, supposing that the output value V_{out(X)} has already been appropriately trimmed to its desired value via trimming the resistance R′_{X}, the output value V_{out(X+1)} may be trimmed via trimming the resistance R′_{X+1} without influencing the already appropriately trimmed output value V_{out(X)}, wherein X may change from 1 to N. That is to say, the output values Vₒᵤₜ₍₁₎˜V_{out(N)} could be successively trimmed to their desired values independently via successively trimming the resistances R′₁˜R′_{N}. In the meanwhile, the resistances R′₁˜R′_{N} could be successively trimmed via successively trimming the leading out positions of the feedback terminals FB₁˜FB_{N} on the trimming units Δ₁˜Δ_{N}. Thus, the output values Vₒᵤₜ₍₁₎˜V_{out(N)} could be successively trimmed to their desired values independently via successively trimming the leading out positions of the feedback terminals FB₁˜FB_{N} on the trimming units Δ₁˜Δ_{N}.

In accordance with one embodiment of the present invention, the trimming unit Δ_{X} is configured to trim the output value V_{out(X)} in a trimming range related to the ratio between ΔR_{X} and R_{X}. In one embodiment, the trimming unit Δ_{X} may have a trimming range of

$$[ - \frac{Δ {R}_{X}}{2} , \frac{Δ {R}_{X}}{2} ]$$

to the resistance R′_{X}, that is to say, the trimming unit Δ_{X} may trim the resistance R′_{X} to have a change (an increase or a decrease) lying in

$$[ - \frac{Δ {R}_{X}}{2} , \frac{Δ {R}_{X}}{2} ] .$$

Thus, the trimming range of the trimming unit Δ_{X} to the output value V_{out(X)} may be:

$$- \frac{Δ {R}_{X}}{2 {R}_{X}} \leq \frac{{V}_{out ( X )}^{′} - {V}_{out ( X )}}{{V}_{out ( X )}} \leq \frac{Δ {R}_{X}}{2 {R}_{X}} ( X = 1 , … , N ) \qquad ( 9 )$$

wherein the label V′_{out(X)} represents a trimmed value of the output value V_{out(X)} that could be achieved after trimming.

In accordance with one embodiment of the present invention, the trimming unit Δ_{X} is configured to trim the output value V_{out(X)} with a predetermined trimming step. In one embodiment, the trimming unit Δ_{X} is configured to trim the resistance R′_{X} with a predetermined trimming step

$$\frac{Δ {R}_{X}}{( {2}^{M} + {2}^{M + 1} + … + {2}^{0} )} ,$$

thus, the trimming unit Δ_{X} could correspondingly trim the output value V_{out(X)} with a predetermined trimming step

$$\frac{1}{( {2}^{M} + {2}^{M - 1} + … + {2}^{0} )} \cdot \frac{Δ {R}_{X}}{{R}_{X}} ,$$

wherein M is a non-negative integer.

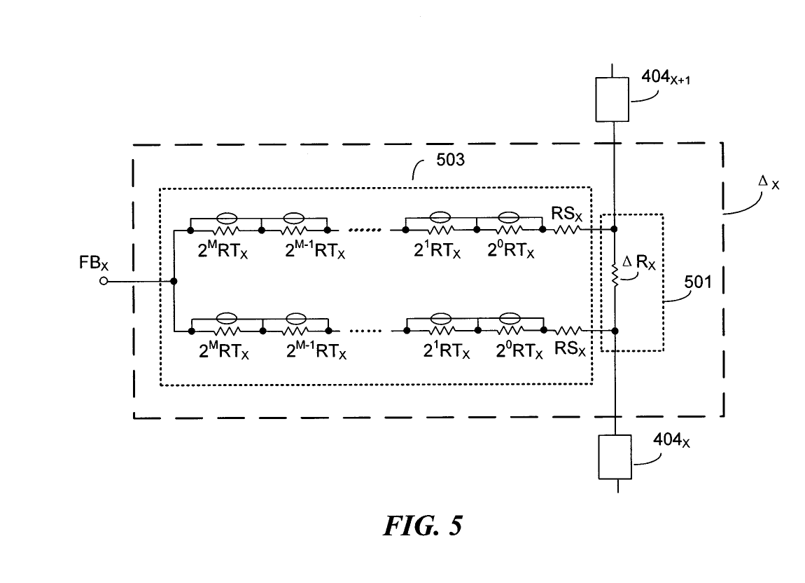

FIG. 5 illustrates schematically a trimming unit Δ_{X} in accordance with one embodiment of the present invention. The trimming unit Δ_{X} may comprise: a first trimming branch 501 having a first terminal coupled to the resistive voltage dividing device 404_{X} and a second terminal coupled to the resistive voltage dividing device 404_{X+1}, wherein the first trimming branch 501 may have a resistance identified by ΔR_{X}; and a second trimming branch 503 comprising a first group of M+1 series coupled trimming resistors having a first terminal coupled to the feedback terminal FB_{X}, and a second terminal coupled to the first terminal of the first trimming branch 501 via a resistor identified by RS_{X}, wherein the first group of M+1 trimming resistors respectively have the resistances successively identified by 2^{M} RT_{X}, 2^{M-1} RT_{X}, . . . , 2⁰ RT_{X}; a second group of M+1 series coupled trimming resistors having a first terminal coupled to the feedback terminal FB_{X}, and a second terminal coupled to the second terminal of the first trimming branch 501 via a resistor identified by RS_{X}, wherein the second group of M+1 trimming resistors respectively have the resistances successively identified by 2^{M} RT_{X}, 2^{M-1} RT_{X}, . . . , 2⁰ RT_{X}; and 2(M+1) trimming fuses correspondingly coupled in parallel with each of the trimming resistors; wherein M is a non-negative integer; and wherein M, M−1, . . . , 0 are the trimming weighted index numbers for the M+1 series coupled trimming resistors respectively having the resistances successively identified by 2^{M} RT_{X}, 2^{M-1} RT_{X}, . . . , 2⁰ RT_{X}. In such configuration, the feedback terminal FB_{X} has a predetermined leading out position at the middle of the second trimming branch 503.

In one embodiment, the first trimming branch 501 may comprise a resistor having the resistance identified by ΔR_{X}.

In one embodiment, the resistance identified by ΔR_{X} of the first trimming branch 501 is much smaller than each of the resistances identified by 2^{M} RT_{X}, 2^{M-1} RT_{X}, . . . , 2⁰ RT_{X}, and RS_{X}. Furthermore, the resistance identified by RS_{X} is much smaller than the total resistance of the M+1 series coupled trimming resistors identified by (2^{M}+2^{M-1}+ . . . +2⁰)RT_{X}. Thus, the trimming unit Δ_{X} has an equivalent resistance substantially equal to the resistance identified by ΔR_{X} and substantially constant during trimming, which ensures the resistance coupled between the output voltage Vₒᵤₜ and ground, i.e., the resistance identified by Rₜₒₜₐₗ in the expression (6), substantially invariant during trimming. In addition, the variation of the leading out position of the feedback terminal FB_{X} on the second trimming branch 503 may be viewed as that the feedback terminal FB_{X} is sliding on the first trimming branch 501, changing the contribution of ΔR_{X} to the resistance R′_{X} expressed by (7). In this way, the trimming unit Δ_{X} could be configured to trim the resistance R′_{X} via varying the leading out position of the feedback terminal FB_{X} on the second trimming branch 503, realizing the trimming to the output value V_{out(X)}.

In one embodiment, the trimming unit Δ_{X} is configured to vary the leading out position of the feedback terminal FB_{X} on the second trimming branch 503 via selectively cutting off a plurality of trimming fuses coupled to a selected plurality of trimming resistors among the first group of M+1 trimming resistors and the second group of M+1 trimming resistors. In one embodiment, the trimming unit Δ_{X} is configured to vary the leading out position of the feedback terminal FB_{X} on the second trimming branch 503 via selectively cutting off a first plurality of trimming fuses coupled to a first plurality of selected trimming resistors among the first group of M+1 trimming resistors, and a second plurality of trimming fuses coupled to a second plurality of selected trimming resistors among the second group of M+1 trimming resistors, wherein the trimming weighted index numbers of the first plurality of selected trimming resistors and the trimming weighted index numbers of the second plurality of selected trimming resistors are complementary such that the total resistance contributed to the second trimming branch 503 by the first group of M+1 trimming resistors and the second group of M+1 trimming resistors maintains at a resistance identified by (2^{M}+2^{M-1}+ . . . +2⁰)RT_{X} during trimming.

In the context of the present disclosure, the trimming weighted index numbers of the first plurality of selected trimming resistors and the trimming weighted index numbers of the second plurality of selected trimming resistors are complementary means that if the trimming weighted index numbers of the first plurality of selected trimming resistors comprise a first plurality of index numbers among the trimming weighted index numbers M, M−1, . . . , 0, then the trimming weighted index numbers of the second plurality of selected trimming resistors comprise the rest of the index numbers among the trimming weighted index numbers M, M−1, . . . , 0, except the first plurality of index numbers. For instance, in one embodiment, if the trimming weighted index numbers of the first selected plurality of trimming resistors comprise 0, then the trimming weighted index numbers of the second selected plurality of trimming resistors comprise M, M−1, . . . , 1, except 0. In this case, the trimming unit Δ_{X} is configured to cut off the trimming fuse coupled to the trimming resistor having the resistance identified by 2⁰ RT_{X} among the first group of M+1 trimming resistors, and complementarily cut off the trimming fuses coupled to the trimming resistors having the resistances respectively identified by 2^{M} RT_{X}, 2^{M-1} RT_{X}, . . . , RT_{X} among the second group of M+1 trimming resistors, resulting in the leading out position of the feedback terminal FB_{X} sliding from

$$\frac{1}{2} Δ {R}_{X} to \frac{{2}^{0}}{{2}^{M} + {2}^{M - 1} + … + {2}^{0}} Δ {R}_{X}$$

on the first trimming branch 501. And thus, the resistance R′_{X} defined by the expression (7) is increased by

$$( \frac{1}{2} - \frac{{2}^{0}}{{2}^{M} + {2}^{M - 1} + … + {2}^{0}} ) Δ {R}_{X} ,$$

resulting in the output value V_{out(X)} expressed by the equation (7) decreased. Those skilled in the art should understand that in other embodiments, the first plurality of index numbers could be freely chosen among the trimming weighted index numbers M, M−1, . . . , 0 according to practical application needs, then the second plurality of index numbers are chosen to be complementary to the first plurality of index numbers, i.e., the second plurality of index numbers comprise the rest of the index numbers among the trimming weighted index numbers M, M−1, . . . , 0, except the first plurality of index numbers. The possible complementary combination of the first plurality of index numbers and the second plurality of index numbers will not be all listed herein.

In the exemplary embodiment shown in FIG. 5, the trimming unit Δ_{X} could be configured to trim the resistance R′_{X} in a trimming range of

$$[ - \frac{Δ {R}_{X}}{2} , \frac{Δ {R}_{X}}{2} ]$$

with a predetermined trimming step

$$\frac{Δ {R}_{X}}{( {2}^{M} + {2}^{M - 1} + … + {2}^{0} )} ,$$

thus, correspondingly the trimming unit Δ_{X} could achieve a trimming range of

$$[ - \frac{Δ {R}_{X}}{2 {R}_{X}} , \frac{Δ {R}_{X}}{2 {R}_{X}} ]$$

to the output value V_{out(X)} as defined by the expression (9) with a predetermined trimming step

$$\frac{1}{( {2}^{M} + {2}^{M - 1} + … + {2}^{0} )} \cdot \frac{Δ {R}_{X}}{{R}_{X}} .$$

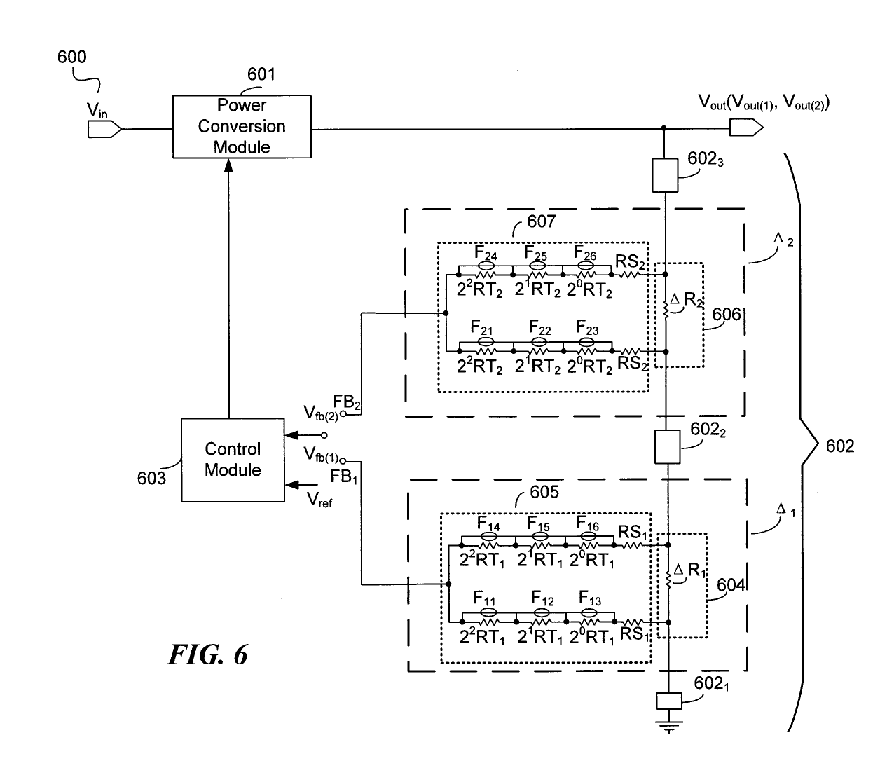

FIG. 6 illustrates schematically an exemplary voltage regulator 600 configurable to provide an output voltage Vₒᵤₜ having two output values Vₒᵤₜ₍₁₎ and Vₒᵤₜ₍₂₎ in accordance with one embodiment of the present invention to help better understand the present invention. The voltage regulator 600 comprises: a power conversion module 601 configured to receive an input voltage Vᵢₙ, and to convert the input voltage Vᵢₙ into an output voltage Vₒᵤₜ configurable to be regulated to two output values Vₒᵤₜ₍₁₎ and Vₒᵤₜ₍₂₎; a feedback and trimming module 602 configured to provide two feedback terminals FB₁ and FB₂ respectively providing two feedback voltages V_{f1(1)} and V_{fb(2)} corresponding to the output values Vₒᵤₜ₍₁₎ and Vₒᵤₜ₍₂₎; and a control module 603 configured to selectively receive one of the two feedback voltages V_{fb(1)} and V_{fb(2)}, and to compare the received feedback voltage V_{fb(1)} or V_{fb(2)} with a reference signal V_{ref} to provide a control signal to the power conversion module 601, wherein the control signal represents an error between the received feedback voltage V_{fb(1)} (or V_{fb(2)}) and the reference signal V_{ref}, and wherein the power conversion module 601 regulates the output voltage Vₒᵤₜ to the output value Vₒᵤₜ₍₁₎ (or Vₒᵤₜ₍₂₎) in response to the control signal.

In one embodiment, as illustrated in FIG. 6, the feedback and trimming module 602 may comprise a group of resistive voltage dividing devices 602₁˜602₃ coupled in series between the output voltage Vₒᵤₜ and ground with a terminal of the resistive voltage dividing device 602₁ connected to ground and a terminal of the resistive voltage dividing device 602₃ connected to the output voltage Vₒᵤₜ; and a group of trimming units Δ₁˜Δ₂ configured to provide the feedback terminals FB₁˜FB₂, wherein the trimming unit Δ₁ is coupled between the resistive voltage dividing devices 602₁ and 602₂, and is configured to provide the feedback terminal FB₁ at the middle of the trimming unit Δ₁ before trimming; and wherein the trimming unit Δ₂ is coupled between the resistive voltage dividing devices 602₂ and 602₃, and is configured to provide the feedback terminal FB₂ at the middle of the trimming unit Δ₂ before trimming; and wherein the trimming units Δ₁ and Δ₂ are further configured to successively trim the leading out positions of the feedback terminals FB₁ and FB₂ respectively on the trimming units Δ₁ and Δ₂ so as to trim the feedback voltages V_{fb(1)} and V_{fb(2)} successively, such that the output values Vₒᵤₜ₍₁₎) and Vₒᵤₜ₍₂₎ could be successively trimmed to their desired values.

In the embodiment shown in FIG. 6, the output values Vₒᵤₜ₍₁₎ and Vₒᵤₜ₍₂₎ may be expressed as follows before trimming:

$$\begin{matrix}{V}_{out ( 1 )} = \frac{{R}_{total} \times Vref}{{R}_{1}^{′}} & ( 10 ) \\ {V}_{out ( 2 )} = \frac{{R}_{total} \times Vref}{{R}_{2}^{′} + {R}_{1}^{′}} \\ wherein {R}_{total} = {R}_{1} + Δ {R}_{1} + {R}_{2} + Δ {R}_{2} + R 3 , {R}_{1}^{′} = {R}_{1} + \frac{1}{2} Δ {R}_{1} , \\ and {R}_{2}^{′} = {R}_{2} + \frac{1}{2} Δ {R}_{1} + \frac{1}{2} Δ {R}_{2} . & ( 11 )\end{matrix}$$

Continuing with FIG. 6, the trimming unit Δ₁ is illustrated to comprise a first trimming branch 604 having a first terminal coupled to the resistive voltage dividing device 602₁ and a second terminal coupled to the resistive voltage dividing device 602₂, wherein the first trimming branch 604 may have a resistance identified by ΔR₁; and a second trimming branch 605 comprising a first group of 3 series coupled trimming resistors having a first terminal coupled to the feedback terminal FB₁, and a second terminal coupled to the first terminal of the first trimming branch 604 via a resistor identified by RS₁, wherein the first group of 3 trimming resistors respectively have the resistances successively identified by 2² RT₁, 2¹ RT₁, and 2⁰ RT₁; a second group of 3 series coupled trimming resistors having a first terminal coupled to the feedback terminal FB₁, and a second terminal coupled to the second terminal of the first trimming branch 604 via a resistor identified by RS₁, wherein the second group of 3 trimming resistors respectively have the resistances successively identified by 2² RT₁, 2¹ RT₁, and 2⁰ RT₁; and 6 trimming fuses F₁₁, F₁₂, F₁₃, F₁₄, F₁₅, and F₁₆, wherein the trimming fuses F₁₁, F₁₂, and F₁₃ are respectively coupled in parallel with the first group of trimming resistors identified by 2² RT₁, 2¹ RT₁, and 2⁰ RT₁, and wherein the trimming fuses F₁₄, F₁₅, and F₁₆ are respectively coupled in parallel with the second group of trimming resistors identified by 2² RT₁, 2¹ RT₁, and 2⁰ RT₁; and wherein 2, 1, and 0 are the trimming weighted index numbers for the trimming resistors respectively having the resistances successively identified by 2² RT₁, 2¹ RT₁, and 2⁰ RT₁. In such configuration, the feedback terminal FB₁ has a predetermined leading out position at the middle of the second trimming branch 605.

Similarly, the trimming unit Δ₂ is illustrated to comprise a first trimming branch 606 having a first terminal coupled to the resistive voltage dividing device 602₂ and a second terminal coupled to the resistive voltage dividing device 602₃, wherein the first trimming branch 606 may have a resistance identified by ΔR₂; and a second trimming branch 607 comprising a third group of 3 series coupled trimming resistors having a first terminal coupled to the feedback terminal FB₂, and a second terminal coupled to the first terminal of the first trimming branch 606 via a resistor identified by RS₂, wherein the third group of 3 trimming resistors respectively have the resistances successively identified by 2² RT₂, 2¹ RT₂, and 2⁰ RT₂; a fourth group of 3 series coupled trimming resistors having a first terminal coupled to the feedback terminal FB₂, and a second terminal coupled to the second terminal of the first trimming branch 606 via a resistor identified by RS₂, wherein the fourth group of 3 trimming resistors respectively have the resistances successively identified by 2² RT₂, 2¹ RT_{Z}, and 2⁰ RT₂; and 6 trimming fuses F₂₁, F₂₂, F₂₃, F₂₄, F₂₅, and F₂₆, wherein the trimming fuses F₂₁, F₂₂, and F₂₃ are respectively coupled in parallel with the third group of trimming resistors identified by 2² RT₂, 2¹ RT₂, and 2⁰ RT₂, and wherein the trimming fuses F₂₄, F₂₅, and F₂₆ are respectively coupled in parallel with the second group of trimming resistors identified by 2² RT₂, 2¹ RT₂, and 2⁰ RT₂; and wherein 2, 1, and 0 are the trimming weighted index numbers for the trimming resistors respectively having the resistances successively identified by 2² RT₂, 2¹ RT₂, and 2⁰ RT₂. In such configuration, the feedback terminal FB₂ has a predetermined leading out position at the middle of the second trimming branch 607.

In the embodiment illustrated in FIG. 6, the resistance identified by ΔR₁ of the first trimming branch 604 of the trimming unit Δ₁ is much smaller than each of the resistances identified by 2² RT₁, 2¹ RT₁, 2⁰ RT₁, and RS₁, and the resistance identified by RS₁ is much smaller than the total resistance of the first/second group of series coupled trimming resistors identified by (2²+2¹+2⁰)RT₁. Furthermore, the resistance identified by ΔR₂ of the first trimming branch 606 of the trimming unit Δ₂ is much smaller than each of the resistances identified by 2² RT₂, 2¹ RT₂, 2⁰ RT₂, and RS₂, and the resistance identified by RS₂ is much smaller than the total resistance of the third/fourth group of series coupled trimming resistors identified by (2²+2¹+2⁰)RT₂. Thus, the trimming unit ΔA₁ has an equivalent resistance substantially equal to the resistance identified by ΔR₁ and substantially constant during trimming; the trimming unit Δ₂ has an equivalent resistance substantially equal to the resistance identified by ΔR₂ and substantially constant during trimming.

When the output values Vₒᵤₜ₍₁₎) and Vₒᵤₜ₍₂₎ in the exemplary embodiment shown in FIG. 6 are deviated from their desired values, the feedback and trimming module 602 may be configured to successively trim the leading out positions of the feedback terminals FB₁ and FB₂ so as to trim the output values Vₒᵤₜ₍₁₎) and Vₒᵤₜ₍₂₎ successively and independently.

Firstly, the trimming unit Δ₁ is configured to trim the leading out position of the feedback terminal FB₁ on the first trimming branch 604 so as to trim the output value Vₒᵤₜ₍₁₎. In one embodiment, the trimming unit Δ₁ is configured to selectively cut off a plurality of trimming fuses among the trimming fuses F₁₁, F₁₂, F₁₃, F₁₄, F₁₅, and F₁₆ to trim the leading out position of the feedback terminal FB₁ on the first trimming branch 604, wherein the trimming weighted index numbers corresponding to the trimming fuses that are cut off among the trimming fuses F₁₁, F₁₂, and F₁₃, and the trimming weighted index numbers corresponding to the trimming fuses that are cut off among the trimming fuses F₁₄, F₁₅, and F₁₆ are complementary such that the total resistance contributed to the second trimming branch 605 by the first group of trimming resistors and the second group of trimming resistors maintains at a resistance identified by (2²+2¹+2⁰)RT₁ during trimming. The following table (T1) lists all the possible ways of cutting off a plurality of trimming fuses among the trimming fuses F₁₁, F₁₂, F₁₃, F₁₄, F₁₅, and F₁₆ to trim the output value Vₒᵤₜ₍₁₎, wherein ΔVₒᵤₜ₍₁₎=V′ₒᵤₜ₍₁₎−Vₒᵤₜ₍₁₎, and wherein V′ₒᵤₜ₍₁₎ is the trimmed value of the output value Vₒᵤₜ₍₁₎ that could be achieved after trimming, and wherein the symbol X represents cut off.

(T1)

| F₁₁ | F₁₂ | F₁₃ | F₁₄ | F₁₅ | F₁₆ | ΔVₒᵤₜ₍₁₎/Vₒᵤₜ₍₁₎ |
|---|---|---|---|---|---|---|
| X | X | X | | | | −3.5ΔR₁/7R₁ |
| X | X | | | | X | −2.5ΔR₁/7R₁ |
| X | | X | | X | | −1.5ΔR₁/7R₁ |
| X | | | | X | X | −0.5ΔR₁/7R₁ |
| | X | X | X | | | 0.5ΔR₁/7R₁ |
| | X | | X | | X | 1.5ΔR₁/7R₁ |
| | | X | X | X | | 2.5ΔR₁/7R₁ |
| | | | X | X | X | 3.5ΔR₁/7R₁ |

The trimming unit Δ₁ could achieve a trimming range of

$$[ - \frac{1}{2} Δ {R}_{1} , \frac{1}{2} Δ {R}_{1} ]$$

to the resistance identified by R′₁ with a trimming step of

$$\frac{1}{{2}^{2} + {2}^{1} + {2}^{0}} Δ {R}_{1} .$$

Thus, correspondingly, the trimming unit Δ₁ could achieve a trimming range of

$$[ - \frac{Δ {R}_{1}}{2 {R}_{1}} , \frac{Δ {R}_{1}}{2 {R}_{1}} ]$$

to the output value Vₒᵤₜ₍₁₎ with a trimming step of

$$\frac{1}{{2}^{2} + {2}^{1} + {2}^{0}} \cdot \frac{Δ {R}_{1}}{{R}_{1}} ,$$

as can be seen from table (T1).

After the output value Vₒᵤₜ₍₁₎) is trimmed, the trimming unit Δ₂ is configured to trim the leading out position of the feedback terminal FB₂ on the first trimming branch 606 so as to trim the output value Vₒᵤₜ₍₂₎. In one embodiment, the trimming unit Δ₂ is configured to selectively cut off a plurality of trimming fuses among the trimming fuses F₂₁, F₂₂, F₂₃, F₂₄, F₂₅, and F₂₆ to trim the leading out position of the feedback terminal FB₂ on the first trimming branch 606, wherein the trimming weighted index numbers corresponding to the trimming fuses that are cut off among the trimming fuses F₂₁, F₂₂, and F₂₃, and the trimming weighted index numbers corresponding to the trimming fuses that are cut off among the trimming fuses F₁₄, F₁₅, and F₁₆ are complementary such that the total resistance contributed to the second trimming branch 607 by the third group of trimming resistors and the fourth group of trimming resistors maintains at a resistance identified by (2²+2¹+2⁰)RT₂ during trimming. The following table (T2) lists all the possible ways of cutting off a plurality of trimming fuses among the trimming fuses F₂₁, F₂₂, F₂₃, F₂₄, F₂₅, and F₂₆ to trim the output value Vₒᵤₜ₍₂₎, wherein ΔVₒᵤₜ₍₂₎=V′ₒᵤₜ₍₂₎−Vₒᵤₜ₍₂₎, and wherein V′ₒᵤₜ₍₂₎ is the trimmed value of the output value Vₒᵤₜ₍₂₎ that could be achieved after trimming, and wherein the symbol X represents cut off.

(T2)

| F₂₁ | F₂₂ | F₂₃ | F₂₄ | F₂₅ | F₂₆ | ΔVₒᵤₜ₍₂₎/Vₒᵤₜ₍₂₎ |
|---|---|---|---|---|---|---|
| X | X | X | | | | −3.5ΔR₂/7R₂ |
| X | X | | | | X | −2.5ΔR₂/7R₂ |
| X | | X | | X | | −1.5ΔR₂/7R₂ |
| X | | | | X | X | −0.5ΔR₂/7R₂ |
| | X | X | X | | | 0.5ΔR₂/7R₂ |
| | X | | X | | X | 1.5ΔR₂/7R₂ |
| | | X | X | X | | 2.5ΔR₂/7R₂ |
| | | | X | X | X | 3.5ΔR₂/7R₂ |

The trimming unit Δ₂ could achieve a trimming range of

$$[ - \frac{1}{2} Δ {R}_{2} , \frac{1}{2} Δ {R}_{2} ]$$

to the resistance identified by R′₂ with a trimming step of

$$\frac{1}{{2}^{2} + {2}^{1} + {2}^{0}} Δ {R}_{2} .$$

Thus, correspondingly, the trimming unit Δ₂ could achieve a trimming range of

$$[ - \frac{Δ {R}_{2}}{2 {R}_{2}} , \frac{Δ {R}_{2}}{2 {R}_{2}} ]$$

to the output value Vₒᵤₜ₍₂₎ with a trimming step of

$$\frac{1}{{2}^{2} + {2}^{1} + {2}^{0}} \cdot \frac{Δ {R}_{2}}{{R}_{2}} ,$$

as can be seen from table (T2).

Various voltage regulators comprising trimming circuits in accordance with various embodiments of the present invention are described with reference to FIGS. 4 to 6. The voltage regulators in accordance with various embodiments of the present invention may be able to provide an output voltage configurable to be regulated to a plurality of output values. When the plurality of output values are deviated from their desired values, the trimming circuits in accordance with various embodiments of the present invention may be able to trim the plurality of output values successively to their desired values, and the trimming for two successive output values are independent. The trimming circuits may utilize a plurality of series coupled voltage dividing devices to provide a plurality of feedback voltages correspondingly related to the plurality of output values, the plurality of feedback voltages are provided at a plurality of feedback terminals led out from a plurality of different positions on the plurality of series coupled voltage dividing devices, and the trimming circuits are configured to trim the plurality of output values by trimming the plurality of leading out positions of the plurality of feedback terminals. Besides, the trimming range and the trimming step to each output value could be set according to practical application requirements. Thus, the output values may be trimmed to their desired values with good precision while reduced power loss and reduced chip size could be expected. This advantage may become more obvious when more than two output values are desired to be provided by the voltage regulators. The trimming circuits in accordance with various embodiments of the present invention have good compatibility may be applied to various types of voltage regulators to provide trimming for the output voltages of the voltage regulators.

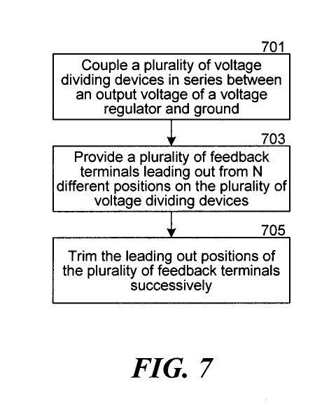

FIG. 7 illustrates a flow chart of a method for trimming an output voltage of a voltage regulator. The trimming method comprises: step 701, coupling a plurality of voltage dividing devices in series between the output voltage of the voltage regulator and ground; step 702, providing a plurality of feedback terminals indexed from 1 to N leading out from N different positions on the plurality of voltage dividing devices, wherein N is a positive integer, and wherein the plurality of feedback terminals having a plurality of feedback voltages indexed from 1 to N respectively corresponding to a plurality of output values indexed from 1 to N of the output voltage; and step 703, trimming the leading out positions of the plurality of feedback terminals indexed from 1 to N on the plurality of voltage dividing devices successively so as to trim the plurality of output values indexed from 1 to N successively and independently.

In one embodiment, the plurality of voltage dividing devices may comprise a group of resistive voltage dividing devices indexed from 1 to N+1, and a group of trimming units indexed from 1 to N. In this circumstance, the step 701 may comprise: coupling the group of resistive voltage dividing devices indexed from 1 to N+1 in series between the output voltage and ground with a terminal of the resistive voltage dividing device indexed by 1 connected to ground and a terminal of the resistive voltage dividing device indexed by N+1 connected to the output voltage; and coupling the trimming unit indexed by X between the resistive voltage dividing device indexed by X and the resistive voltage dividing device indexed by X+1; wherein X may change from 1 to N. The step 702 may comprise: providing the feedback terminal indexed by X at a predetermined leading out position on the trimming unit indexed by X before trimming, wherein X may change from 1 to N. And the step 703 may comprise: trimming the leading out positions of the plurality of feedback terminals indexed from 1 to N on the trimming units indexed from 1 to N respectively and successively so as to trim the plurality of output values indexed from 1 to N successively and independently.

From the foregoing, it will be appreciated that specific embodiments of the technology have been described herein for purposes of illustration, but that various modifications may be made without deviating from the disclosure. Many of the elements of one embodiment may be combined with other embodiments in addition to or in lieu of the elements of the other embodiments. Accordingly, the disclosure is not limited except as by the appended claims.

I/We claim:

1. A voltage regulator comprising:
a power conversion module configured to receive an input voltage, and to convert the input voltage into an output voltage configurable to be regulated to a plurality of output values indexed from 1 to N, wherein N is a positive integer;
a feedback and trimming module comprising a plurality of voltage dividing devices coupled in series between the output voltage and ground, wherein the feedback and trimming module is configured to provide a plurality of feedback terminals indexed from 1 to N leading out from N different positions on the plurality of voltage dividing devices, and wherein the plurality of feedback terminals indexed from 1 to N are configured to provide a plurality of feedback voltages indexed from 1 to N respectively corresponding to the plurality of output values indexed from 1 to N; and
a control module configured to selectively receive one of the plurality of feedback voltages indexed by X a time, and to compare the received feedback voltage indexed by X with a reference signal to provide a control signal to the power conversion module, wherein the control signal represents an error between the received feedback voltage indexed by X and the reference signal, and wherein the power conversion module regulates the output voltage to the output value indexed by X corresponding to the received feedback voltage indexed by X in response to the control signal, and wherein X changes from 1 to N; and wherein
the feedback and trimming module is further configured to successively trim the leading out positions of the plurality of feedback terminals indexed from 1 to N on the plurality of voltage dividing devices so as to successively trim the plurality of output values indexed from 1 to N to their desired values independently.

2. The voltage regulator of claim 1, wherein the feedback and trimming module comprises:
a group of resistive voltage dividing devices indexed from 1 to N+1 coupled in series between the output voltage and ground with a terminal of the resistive voltage dividing device indexed by 1 connected to ground and a terminal of the resistive voltage dividing device indexed by N+1 connected to the output voltage; and
a group of trimming units indexed from 1 to N configured to provide the plurality of feedback terminals indexed from 1 to N, wherein
the trimming unit indexed by X is coupled between the resistive voltage dividing device indexed by X and the resistive voltage dividing device indexed by X+1, and wherein
the trimming unit indexed by X is configured to provide the feedback terminal indexed by X at a predetermined leading out position before trimming, and wherein
the trimming unit indexed by X is further configured to trim the leading out position of the feedback terminal indexed by X on the trimming unit indexed by X so as to trim the output value indexed by X to its desired value, and wherein
X successively changes from 1 to N.

3. The voltage regulator of claim 2, wherein
the resistive voltage dividing device indexed by X has an equivalent resistance identified by R_{X}; and wherein
the trimming unit indexed by X has an equivalent resistance identified by ΔR_{X}; and wherein
the trimming unit indexed by X is configured to trim the output value indexed by X in a trimming range related to the ratio between ΔR_{X} and R_{X}.

4. The voltage regulator of claim 2, wherein the trimming unit indexed by X is configured to trim the output value indexed by X with a predetermined trimming step.

5. The voltage regulator of claim 2, wherein the trimming unit indexed by X comprises:
a first trimming branch having a first terminal coupled to the resistive voltage dividing device indexed by X and a second terminal coupled to the resistive voltage dividing device indexed by X+1, wherein the first trimming branch has a resistance identified by ΔR_{X}; and
a second trimming branch comprising:
a first group of M+1 series coupled trimming resistors having a first terminal coupled to the feedback terminal indexed by X, and a second terminal coupled to the first terminal of the first trimming branch via a resistor identified by RS_{X}, wherein the first group of M+1 trimming resistors respectively have the resistances successively identified by 2^{M} RT_{X}, 2^{M-1} RT_{X}, . . . , 2⁰ RT_{X};
a second group of M+1 series coupled trimming resistors having a first terminal coupled to the feedback terminal indexed by X, and a second terminal coupled to the second terminal of the first trimming branch via a resistor identified by RS_{X}, wherein the second group of M+1 trimming resistors respectively have the resistances successively identified by 2^{M} RT_{X}, 2^{M-1} RT_{X}, . . . , 2⁰ RT_{X}; and
2(M+1) trimming fuses correspondingly coupled in parallel with each of the trimming resistors; wherein
M is a non-negative integer; and wherein
M, M−1, . . . , 0 are the trimming weighted index numbers for the M+1 series coupled trimming resistors respectively having the resistances successively identified by 2^{M} RT_{X}, 2^{M-1} RT_{X}, . . . , 2⁰ RT_{X}.

6. The voltage regulator of claim 5, wherein the resistive voltage dividing device indexed by X has an equivalent resistance identified by R_{X}; and wherein the trimming unit indexed by X has a trimming range of
$$[ - \frac{Δ {R}_{X}}{2 {R}_{X}} , \frac{Δ {R}_{X}}{2 {R}_{X}} ]$$
to the output value indexed by X.

7. The voltage regulator of claim 5, wherein the resistive voltage dividing device indexed by X has an equivalent resistance identified by R_{X}; and wherein the trimming unit indexed by X has a predetermined trimming step of
$$\frac{1}{( {2}^{M} + {2}^{M - 1} + … + {2}^{0} )} \cdot \frac{Δ {R}_{X}}{{R}_{X}}$$
to the output value indexed by X.

8. The voltage regulator of claim 5, wherein the resistance identified by ΔR_{X}, is much smaller than each of the resistances identified by 2^{M} RT_{X}, 2^{M-1} RT_{X}, . . . , 2⁰ RT_{X}, and RS_{X}, and wherein the resistance identified by RS_{X} is much smaller than the total resistance of the M+1 series coupled trimming resistors identified by (2^{M}+2^{M-1}+ . . . +2⁰)RT_{X}.

9. The voltage regulator of claim 5, wherein the trimming unit indexed by X is configured to trim the leading out position of the feedback terminal indexed by X on the second trimming branch via selectively cutting off a plurality of trimming fuses coupled to a selected plurality of trimming resistors among the first group of M+1 trimming resistors and the second group of M+1 trimming resistors.

10. The voltage regulator of claim 5, wherein the trimming unit indexed by X is configured to trim the leading out position of the feedback terminal indexed by X on the second trimming branch via selectively cutting off a first plurality of trimming fuses coupled to a first plurality of selected trimming resistors among the first group of M+1 trimming resistors, and a second plurality of trimming fuses coupled to a second plurality of selected trimming resistors among the second group of M+1 trimming resistors, wherein the trimming weighted index numbers of the first plurality of selected trimming resistors and the trimming weighted index numbers of the second plurality of selected trimming resistors are complementary such that the total resistance contributed to the second trimming branch by the first group of M+1 trimming resistors and the second group of M+1 trimming resistors maintains at a resistance identified by (2^{M}+2^{M-1}+ . . . 2⁰)RT_{X} during trimming.

11. A trimming circuit comprising:
an input terminal configured to receive an output voltage of a voltage regulator configurable to be regulated to a plurality of output values indexed from 1 to N, wherein N is a positive integer;
a plurality of feedback terminals indexed from 1 to N configured to provide a plurality of feedback voltages indexed from 1 to N corresponding to the plurality of output values indexed from 1 to N; and
a plurality of voltage dividing devices coupled in series between the input terminal and ground, wherein the plurality of feedback terminals indexed from 1 to N are provided from N different leading out positions on the plurality of voltage dividing devices, and wherein the plurality of output values indexed from 1 to N corresponding to the plurality of feedback voltages indexed from 1 to N are successively and independently trimmed to their desired values via successively trimming the leading out positions of the plurality of feedback terminals indexed from 1 to N on the plurality of voltage dividing devices.

12. The trimming circuit of claim 11, wherein the plurality of voltage dividing devices comprises:
a group of resistive voltage dividing devices indexed from 1 to N+1 coupled in series between the output voltage and ground with a terminal of the resistive voltage dividing device indexed by 1 connected to ground and a terminal of the resistive voltage dividing device indexed by N+1 connected to the output voltage; and
a group of trimming units indexed from 1 to N configured to provide the plurality of feedback terminals indexed from 1 to N, wherein
the trimming unit indexed by X is coupled between the resistive voltage dividing device indexed by X and the resistive voltage dividing device indexed by X+1, and wherein
the trimming unit indexed by X is configured to provide the feedback terminal indexed by X at a predetermined leading out position before trimming, and wherein
the trimming unit indexed by X is further configured to trim the leading out position of the feedback terminal indexed by X on the trimming unit indexed by X so as to trim the output value indexed by X to its desired value, and wherein
X successively changes from 1 to N.

13. The trimming circuit of claim 12, wherein
the resistive voltage dividing device indexed by X has an equivalent resistance identified by R_{X}; and wherein
the trimming unit indexed by X has an equivalent resistance identified by ΔR_{X}; and wherein
the trimming for the output value indexed by X has a trimming range related to the ratio between ΔR_{X} and R_{X}.

14. The trimming circuit of claim 12, wherein the trimming for the output value indexed by X has a predetermined trimming step.

15. The trimming circuit of claim 12, wherein trimming unit indexed by X comprises:
a first trimming branch having a first terminal coupled to the resistive voltage dividing device indexed by X and a second terminal coupled to the resistive voltage dividing device indexed by X+1, wherein the first trimming branch comprises a resistor having a resistance identified by ΔR_{X}; and
a second trimming branch comprising:
a first group of M+1 series coupled trimming resistors having a first terminal coupled to the feedback terminal indexed by X, and a second terminal coupled to the first terminal of the first trimming branch via a resistor identified by RS_{X}, wherein the first group of M+1 trimming resistors respectively have the resistances successively identified by 2^{M} RT_{X}, 2^{M-1} RT_{X}, . . . , 2⁰ RT_{X};
a second group of M+1 series coupled trimming resistors having a first terminal coupled to the X^{th} feedback terminal, and a second terminal coupled to the second terminal of the first trimming branch via a resistor identified by RS_{X}, wherein the second group of M+1 trimming resistors respectively have the resistances successively identified by 2^{M} RT_{X}, 2^{M-1} RT_{X}, . . . , 2⁰ RT_{X}; and
2(M+1) trimming fuses correspondingly coupled in parallel with each of the trimming resistors; wherein
M is a non-negative integer; and wherein
M, M−1, . . . , 0 are the trimming weighted index numbers for the M+1 series coupled trimming resistors respectively having the resistances successively identified by 2^{M} RT_{X}, 2^{M-1} RT_{X}, . . . , 2⁰ RT_{X}.

16. The trimming circuit of claim 15, wherein the resistance identified by ΔR_{X} is much smaller than the resistances identified by 2^{M} RT_{X}, 2^{M-1} RT_{X}, . . . , 2⁰ RT_{X}, and RS_{X}, and wherein the resistance identified by RS_{X} is much smaller than the total resistance of the M+1 series coupled trimming resistors identified by (2^{M}+2^{M-1}+ . . . 2⁰)RT_{X}.

17. The trimming circuit of claim 15, wherein the trimming unit indexed by X is configured to trim the leading out position of the feedback terminal indexed by X on the second trimming branch via selectively cutting off a plurality of trimming fuses coupled to a selected plurality of trimming resistors among the first group of M+1 trimming resistors and the second group of M+1 trimming resistors.

18. The trimming circuit of claim 15, wherein the trimming unit indexed by X is configured to trim the leading out position of the feedback terminal indexed by X on the second trimming branch via selectively cutting off a first plurality of trimming fuses coupled to a first plurality of selected trimming resistors among the first group of M+1 trimming resistors, and a second plurality of trimming fuses coupled to a second plurality of selected trimming resistors among the second group of M+1 trimming resistors, wherein the trimming weighted index numbers of the first plurality of selected trimming resistors and the trimming weighted index numbers of the second plurality of selected trimming resistors are complementary such that the total resistance contributed to the second trimming branch by the first group of M+1 trimming resistors and the second group of M+1 trimming resistors maintains at a resistance identified by (2^{M}+2^{M-1}+ . . . 2⁰)RT_{X} during trimming.

19. A method for trimming an output voltage of a voltage regulator, comprising:
coupling a plurality of voltage dividing devices in series between the output voltage and ground;
providing a plurality of feedback terminals indexed from 1 to N leading out from N different positions on the plurality of voltage dividing devices, wherein N is a positive integer, and wherein the plurality of feedback terminals having a plurality of feedback voltages indexed from 1 to N respectively corresponding to a plurality of output values indexed from 1 to N of the output voltage; and
trimming the leading out positions of the plurality of feedback terminals indexed from 1 to N on the plurality of voltage dividing devices successively so as to trim the plurality of output values indexed from 1 to N successively and independently.

20. The method of claim 19, wherein the plurality of voltage dividing devices comprises a group of resistive voltage dividing devices indexed from 1 to N+1, and a group of trimming units indexed from 1 to N, and wherein the method further comprises:
coupling the group of resistive voltage dividing devices indexed from 1 to N+1 in series between the output voltage and ground with a terminal of the resistive voltage dividing device indexed by 1 connected to ground and a terminal of the resistive voltage dividing device indexed by N+1 connected to the output voltage;
coupling the trimming unit indexed by X between the resistive voltage dividing device indexed by X and the resistive voltage dividing device indexed by X+1, wherein X changes from 1 to N;
providing the feedback terminal indexed by X at a predetermined leading out position on the trimming unit indexed by X before trimming, wherein X changes from 1 to N; and
trimming the leading out positions of the plurality of feedback terminals indexed from 1 to N on the trimming units indexed from 1 to N respectively and successively so as to trim the plurality of output values indexed from 1 to N successively and independently.
